(19) United States
(12) Patent Application Publication
(10) Pub. No.: US 2011/0040627 A1
(43) Pub. Date: Feb. 17, 2011

(54) VIRAL ADVERTISEMENTS

(75) Inventors: Brett D. Brewer, Sammamish, WA (US); Timothy D. Sharpe, Redmond, WA (US); Jason Garms, Woodinville, WA (US); Melissa W. Dunn, Woodinville, WA (US); Abhiram G. Khune, Sammamish, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/538,937

(22) Filed: Aug. 11, 2009

(51) Int. Cl. G06Q 30/00

(52) U.S. Cl. 705/14.64

(57) ABSTRACT

The claimed subject matter provides systems and/or methods for propagating viral advertising content to multiple mobile devices without utilizing an intermediary interposing hosting and/or distribution service. The system includes devices that receive viral advertising content on a mobile device, modify the viral advertising content with further viral advertising content previously received from a disparate mobile device, determine sets of recipients to whom the modified viral advertising content can be perceived as compelling, and disseminates the modified viral advertising content to the sets of recipients each of whom can be associated with a disparate mobile device.

### BACKGROUND

Advertising is a form of communication that attempts to persuade potential customers to purchase or to consume more of a particular brand of product or service. Many advertisements are designed to generate increased consumption of these products and services through the creation and reinforcement of brand image or brand loyalty. Every major medium has been used to deliver such advertisements, including television, radio, cinema, magazines, the Internet, and billboards. Nevertheless, most of the advertising mechanisms utilized to date have been interruptive or disruptive in nature. For example, during most television programs when the narrative is building to one of the many climactic points, an advertising interlude is inevitably scheduled, interrupting or disrupting program flow and forcing the viewer to watch the advertisements played in order not to miss the climactic point of the narrative in the television program. More often than not the advertising played during such interludes have no appeal whatsoever to the viewer and in many cases causes the viewer to become irritated and to look unfavorably on the advertiser, destroying and/or negatively reinforcing any brand loyalty the advertiser may have previously accrued.

Viral marketing or viral advertising are marketing techniques that can use social networks to produce increases in brand awareness or to achieve other marketing objectives through viral processes analogous to the spread of pathological or computer viruses. Viral marketing or advertising can take place via word of mouth and/or can be enhanced through the facilities of computer networks, such as the Internet. Viral marketing or advertising encourages people to distribute marketing messages voluntarily through a centralized sharing website where people can upload, view, and share such content.

The subject matter as claimed is directed toward resolving or at the very least mitigating, one or all the problems elucidated above.

### SUMMARY

The following presents a simplified summary in order to provide a basic understanding of some aspects of the disclosed subject matter. This summary is not an extensive overview, and it is not intended to identify key/critical elements or to delineate the scope thereof Its sole purpose is to present some concepts in a simplified form as a prelude to the more detailed description that is presented later.

Conventionally, viral-based advertisements are shared among users by posting the advertisement to a central database or service and providing to friends a link to the central service that references the advertisement. The claimed matter relates to viral advertisement sharing that by-pass the central service and allows advertisements to be delivered directly to friends or colleagues. The advertiser benefits by such dissemination of the advertisement, which can be maximized by creating popular advertising. Moreover, an ecosystem can be developed that helps target particular demographics. For instance, if a target demographic prefers cute advertising over irreverent comedy (as indicated by the system) then the advertiser can utilize such information when producing advertising content to obtain additional benefits. In various aspects of the claimed matter, notions of revenue sharing can be included as well as digital rights management (DRM). In the latter case, digital rights management (DRM) can be employed for a variety of reasons, an example of which can be to ensure that an advertisement that is potentially comic to a proportion of the target demographic, but nevertheless is potentially offensive to the demographic at large (e.g., based upon geographic region, culture, politics, religion, . . . ) is not playable to those demographics that are likely to be offended. In a further aspect, viral advertisements can be utilized in connection with surfaces not traditionally utilized, such as surfaces in an automobile.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that effectuates and/or facilitates dispersion of viral advertising content to a disparity of mobile devices in accordance with the claimed subject matter.

FIG. 2 depicts a mobile device that effectuates and/or facilitates dissemination of viral advertising content to a plurality of mobile devices in accordance with aspects of the claimed subject matter.

FIG. 3 depiction of a viewing component that effectuates and/or facilitates dispatch of viral advertising content directly to a multitude of devices in accordance with one or more principles of the claimed subject matter.

FIG. 4 provides exemplification of a forwarding component that in accordance with the claimed subject matter facilitates and/or effectuates distribution of viral advertising content directly to one or more devices.

FIG. 5 provides illustration of a mobile device in accordance with further aspects of the claimed subject matter.

FIG. 6 illustrates a flow diagram of a machine implemented methodology that facilitates and/or effectuates distribution of viral advertising content directly to one or more devices in accordance with aspects of the claimed subject matter.

FIG. 7 illustrates a machine implemented method that effectuates and/or facilitates dispersion of viral advertising content to a disparity of mobile devices in accordance with the claimed subject matter.

FIG. 8 illustrates a block diagram of a computer operable to execute the disclosed system in accordance with an aspect of the claimed subject matter.

FIG. 9 illustrates a schematic block diagram of an illustrative computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

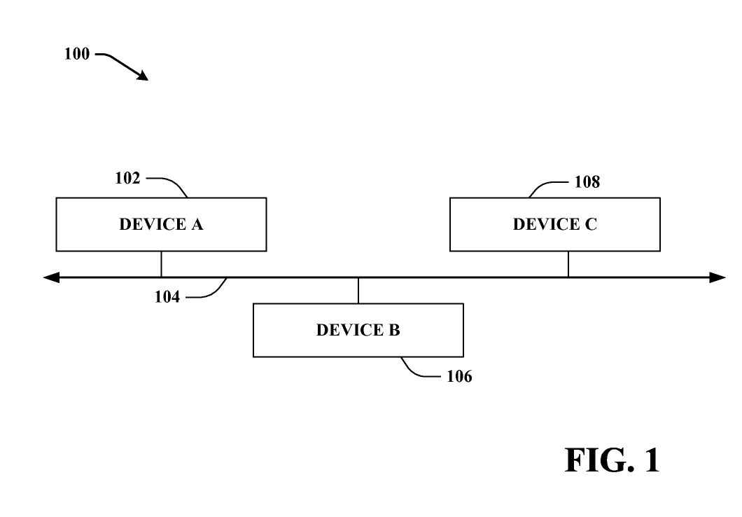

FIG. 1 illustrates a system 100 that effectuates and/or facilitates dispersion of viral advertising content to a disparity of mobile devices in accordance with aspects of the claimed subject matter. As depicted system 100 can include device A 102 that, via network topology and/or cloud 104, can be in continuous and/or operative or sporadic and/or intermittent communication with device B 106, and device C 108. Device A 102, device B 106, and device C 108 can be implemented entirely in hardware and/or a combination of hardware and/or software in execution. Further, device A 102, device B 106, or device C 108 can be incorporated within and/or associated with other compatible components. Additionally, one or more of device A 102, device B 106, or device C 108 can be, but is not limited to, any type of machine that includes a processor and/or is capable of effective communication with network topology and/or cloud 104. Illustrative machines that can comprise device A 102, device B 106, or device C 108 can include desktop computers, server class computing devices, cell phones, smart phones, laptop computers, notebook computers, Tablet PCs, consumer and/or industrial devices and/or appliances, hand-held devices, personal digital assistants, multimedia Internet mobile phones, multimedia players, and the like.

Research has indicated that people will typically share advertising content where the content is deemed interesting, useful, entertaining, and/or engaging. The premise for such an assertion is that advertisements, in order to be thought of as appealing have to be useful, entertaining and/or engaging in of themselves, in addition to also enhancing the useful, entertaining, and/or engagingness of the application, or experience, within which the advertisement resides. Accordingly as depicted, device A 102 can be in receipt of advertising content (e.g., video, audio, text, email, text message, voice mail, . . . ) that the user (e.g., having viewed, listened to, or otherwise perceived, the content) deems useful, entertaining, and/or engaging. The user of device A 102, on determining that the received advertising content is entertaining, useful, and/or engaging, can selectively forward such content to device B 106 and/or device C 108 via network topology and/or cloud 104, so that users associated with device B 106, and/or device C 108 can determine whether or not they too find the advertising content equally appealing (e.g., useful, engaging and/or entertaining) or whether they find the forwarded advertising content potentially offensive or in bad taste. It will be noted from the foregoing, without limitation or loss of generality, that device A 102, device B 106, and/or device C 108 are not central servers where users' would typically upload such advertising content for future download. Rather it will be appreciated by those reasonably conversant in the field of endeavor, when device A 102 forwards interesting, useful, entertaining, and/or engaging content to device B 106 and/or device C 108 that device A 102 dispatches the content directly to device B 106 and/or device C 108 without the necessity of an intermediary interposed central content repository from which device B 106 and/or device C 108 would normally download such content.

Network topology and/or cloud 104 can include any viable communication and/or broadcast technology, for example, wired and/or wireless modalities and/or technologies can be utilized to effectuate the claimed subject matter. Moreover, network topology and/or cloud 104 can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Additionally, network topology and/or cloud 104 can include or encompass communications or interchange utilizing Near-Field Communications (NFC) and/or communications utilizing electrical conductance through the human skin, for example.

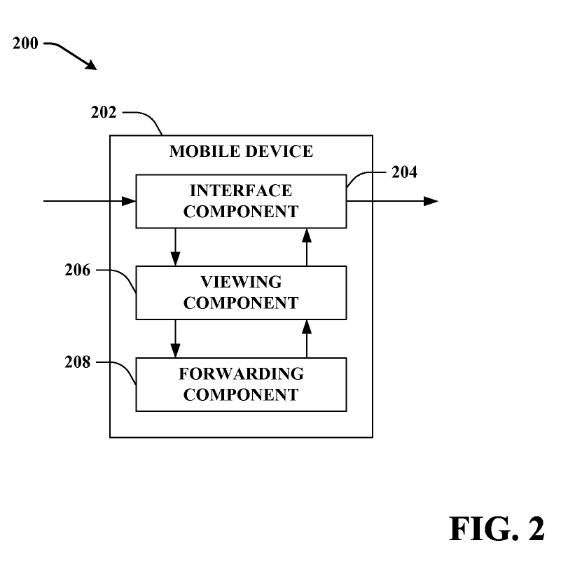

FIG. 2 provides illustration 200 of a mobile device 202 that effectuates and/or facilitates dissemination of viral advertising content to a plurality of mobile devices in accordance with aspects of the claimed subject matter. Mobile device 202 can be any known handheld computing platform and can include any machine that includes a processor and/or is capable of effective communications with disparate other devices utilizing a wired and/or wireless network medium (e.g., network topology and/or cloud 104). For example, mobile device 202 can be any type of mechanism, machine, device, facility, and/or instrument such as embedded auto personal computers (AutoPCs), appropriately instrumented hand-held personal computers (e.g., that have accelerometers), Tablet PC's, laptop computers, notebook computers, cell phones, smart phones, portable consumer appliances and/or instrumentation, mobile industrial devices and/or components, hand-held devices, personal digital assistants, multimedia Internet enabled phones, multimedia players, and the like.

As depicted mobile device 202 can include any suitable and/or necessary interface component 204 (herein referred to as “interface 204”), that can provide various adapters, connectors, channels, communication pathways and/or modalities, etc. to integrate mobile device 202 and its associated and ancillary components into virtually any operating and/or database system(s) and/or with one another. Additionally, interface component 204 can provide various adapters, connectors, channels, communication pathways and/or methodologies, etc. to effectuate and facilitate interaction with and between mobile device 202 and its affiliated components, and/or any other component, data, and the like associated with system 200. Interface 204 as illustrated can receive advertising content directed to it from another mobile device and can thereafter either convey the received advertising content to a viewing component 206 for immediate viewing by a user of mobile device 202 or can persist (e.g., to a storage means associated with mobile device 202) the received advertising content so that the content can be viewed by the user at some subsequent or more convenient time. Moreover, interface 204 can also be employed when the user of mobile device 202 forwards (e.g., through utilization of forwarding component 208) the received, viewed and/or modified content to another mobile device.

As people (e.g., users of mobile device 202) see or view viral content (e.g., advertising content, such as video, audio, text, emails, telephonic voice messages, text messages, etc. that is rapidly shared and distributed amongst users) that is appealing to them (or while not appealing to them per se they nonetheless perceive will be appealing or beneficial to one or more of their acquaintances) they invariably wish to share such content with their friends, acquaintances, and colleagues who they perceive as sharing a common mindset and/or sense of humor, for example. Thus, rather than sending such content to an intermediary interposing hosting and/or distribution service, a user through the facilities and functionalities associated with mobile device 202, after having viewed the advertising content through utilization of viewing component 206, can forward or directly disseminate the received content to a friend's mobile device. As will be appreciated, viewing component 206 can be a display aspect that is now typical and usual on most handheld or mobile processing units. Nevertheless, in addition to the typical visual and/or textual display aspects associated with mobile device 202, viewing component 206 can also include monitoring and/or accounting features that can be used to determine whether or not content has been viewed (or partially viewed) by the user, how many times the content (or segments of the content) has been viewed (or not viewed), and/or the number of times that particular content (or portions thereof) have been disseminated (or not disseminated) from mobile device 202 to one or more disparate other devices. It should be noted at this juncture, without limitation or loss of generality, that a distinction can be made between the dissemination and/or download of content (or portions thereof) and the viewing of content (or portions thereof). In the former case, dissemination and/or download is not necessarily indication that content (or portions thereof) has been viewed, whereas in the latter case viewing of content (or portions thereof) can be indication that content (or portions thereof) has been distributed and viewed. Nevertheless, in either case account can be taken of both events and as discussed below, appropriate tariffs can be allocated for such action or inaction.

Additionally, mobile device 202 can include forwarding component 208 that, in concert with viewing component 206 and interface 204, can be employed to directly dispatch or distribute interesting, useful, engaging, and/or entertaining content to one or more diverse devices for viewing by their respective users. As will be comprehended by those moderately conversant in this field of endeavor such other disparate and diverse devices can include components implemented entirely in hardware and/or as a combination of hardware and/or software in execution. Further, such other diverse devices can be, but are not limited to, any type of engine, machine, instrument of conversion, or mode of production that includes a processor and/or is capable of effective and/or operative communications with network topology and/or cloud 104. Illustrative instruments of conversion, modes of production, engines, mechanisms, devices, and/or machinery that can comprise these devices or components can include desktop computers, server class computing devices and/or databases, cell phones, smart phones, laptop computers, notebook computers, Tablet PCs, portable and/or standalone consumer and/or industrial devices and/or appliances and/or processes, hand-held devices, personal digital assistants, multimedia Internet enabled mobile phones, multimedia players, and the like. Moreover, forwarding component 208 can include modification and/or digital rights management (DRM) functionalities and/or facilities that can be utilized by the user, for example, to create mashups or hybridizations of multiple sources (e.g., emails, text messaging, voice messages, video, audio, text, pictures, . . . ) into a single integrated whole and to keep track of the various digital rights attributions that can be, or might be, impinged through such hybridization or mashup.

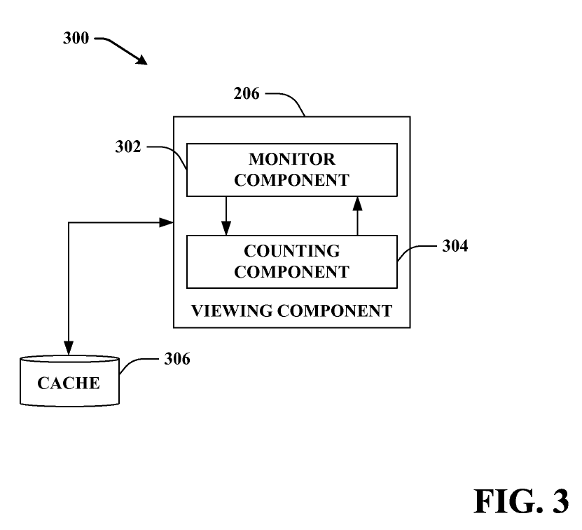

FIG. 3 provides depiction 300 of a viewing component 206 that effectuates and/or facilitates dispatch of viral advertising content directly to a multitude of devices in accordance with one or more principles of the claimed subject matter. As illustrated, viewing component 206 can include monitor component 302 that can be employed every time that the user views or displays received distributed content in order to determine whether or not content (wholly or partially) has been viewed on mobile device 202. By utilizing monitor component 302 a more accurate metric as to whether or not content has been perceived by the user can be ascertained. Thus, rather than merely enumerating the fact that viral content has been received on mobile device 202, the claimed subject matter, and in particular, monitor component 302, can be utilized to determine whether or not received content has wholly or partially been viewed by the user of mobile device 102. In this manner the popularity of particular distributed content or parts thereof, can be gauged and further monetization of the respective segments assessed.

Additionally, viewing component 206 can include counting component 304 that can assess or determine how many times content (or segments of the content) has been viewed, and/or the number of times that particular content (or portions thereof) have been disseminated from mobile device 202 to one or more disparate other devices. Moreover, in conjunction with monitor component 302, counting component 304 can quantify and provide statistics that can be utilized to ascertain the popularity of distributed content or parts thereof for the purposes of monetizing the distribution of viral content. For example, more popular aspects of distributed viral content can be assessed a higher tariff than less popular aspects and as such when and if content, either in its entirety or selected portions thereof, is forwarded or disseminated to further devices, the relative tariffs can be appropriately attributed to the various portions of content for the purpose of providing a monetization scheme whereby the user who dispatched the content is awarded a money reward by the advertiser for such dissemination based at least in part on the relative tariff weights associated with the distributed content or the number of further devices to which the content is disseminated and/or subsequently viewed. Moreover, monetization can also be facilitated when a viewer (or user) on viewing the distributed content is rewarded for merely viewing the content (or portions thereof) on his or her device. It should be noted, without limitation or loss of generality, that tariffs can typically be associated with the number of times that content, or selected portions thereof, is distributed and/or viewed, thus, where segments of the content are not disseminated and/or viewed and/or are skipped over, no tariff (or a negative tariff, a diminished tariff, or a proportional negative tariff) can generally be attributed to unviewed and/or undistributed segments of content or the unviewed and/or undistributed content in its entirety.

Viewing component 206 can also be communicatively coupled, or otherwise, associated with cache 306 that can include any suitable data necessary for viewing component 206 (and for that matter mobile device 202 at large) to facilitate its aims. For instance, cache 306 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate networks, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information obtained from the disparate network, ratings from a website, a credit score, geographical location, a donation to charity, or any other information related to software, applications, web conferencing, and/or any suitable data related to transactions, etc.

It is to be appreciated that cache 306 can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Cache 306 of the subject systems and methods is intended to comprise, without being limited to, these and any other suitable types of memory. In addition, it is to be appreciated that cache 306 can be a server, a database, a hard drive, and the like.

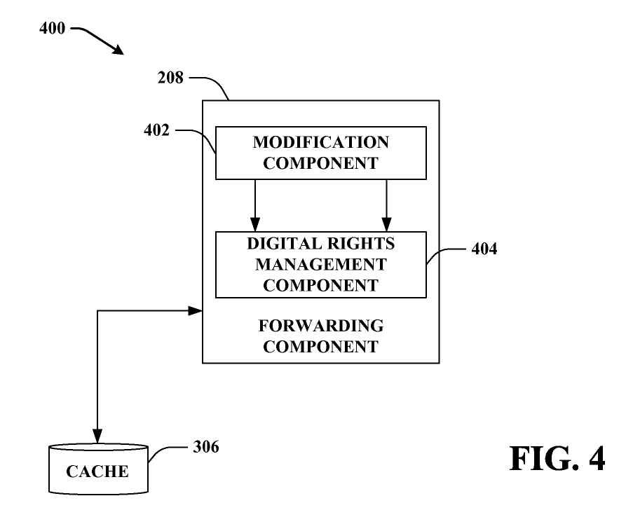

FIG. 4 provides exemplification 400 of a forwarding component 208 that in accordance with the claimed subject matter facilitates and/or effectuates distribution of viral advertising content directly to one or more devices. Forwarding component 208 can include modification component 402 that the user can utilize to create mashups or hybridizations of various disparate content which he/she can subsequently forward to his friends. As will be appreciated by those of ordinary skill, modification component 402 can provide the user a set of facilities to enable him/her to modify content by arranging and/or splicing together various segments of previously received and disparate content as well as content generated through the user's own endeavors to create, for example, a parody (or derivative) of the underlying content.

Further, forwarding component 208 can also include digital rights management (DRM) component 404 that can be utilized in concert with modification component 402 to track the various digital rights associated with the various content that the user has spliced or arranged together. Additionally, as will be appreciated, there can be aspects of distributed content (e.g., logos, product placements, etc.) that the original distributor (e.g., the advertiser) wishes to be maintained despite the user's attempts to obviate such content. In order to facilitate this aspect, digital rights management (DRM) component 404 can ensure that these aspects of are present or remain persistent regardless of the user's attempts to negate them from the viral content. In this manner the original distributor's product placement, for instance, can receive appropriate attribution. Additionally and/or alternatively, there can be aspects of distributed content (e.g., segments or sub-segments) that the initial distributor (e.g., advertiser) does not want subsequent user's to associate with user created mashups or hybridizations of any kind. Further, an original distributor (e.g., advertiser) may not want their content juxtaposed with content from a competitor. Accordingly, digital rights management (DRM) component 404, in concert with modification component 402 for example, can ensure that such distributed content, or identified portions thereof, is immutable and/or non-associable with other content, or selected content.

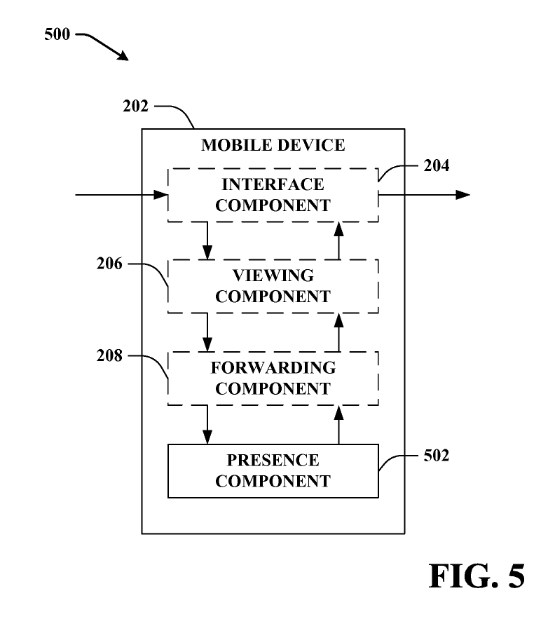

FIG. 5 provides illustration 500 of mobile device 202 in accordance with further aspects of the claimed subject matter. Since the functionality and facilities of interface 204, viewing component 206, and forwarding component 208 have been previously elucidated with respect to FIG. 2, above, a detailed description of such features have been omitted to avoid needless prolixity and for the sake of brevity and conciseness. Thus, in addition to the foregoing components, mobile device 202 can also include presence component 502 that can be utilized to effectively mask or unmask the proximity and/or presence of mobile device 202 to other devices within which it finds itself. This functionality can be employed where the user does not want his/her presence detected and/or to ensure that viral advertising is not directed to mobile device 202. It should be noted without limitation or loss of generality that while presence component 502 can be used to deter the unsolicited receipt of content to the mobile device, the user, if they so wish, can still disseminate viral content to other devices that are receptive to such content.

In addition to the foregoing elucidated components mobile device 202 can additionally include a component directed toward taking advantage of any information fission which may be inherent to a process (e.g., receiving and/or deciphering inputs) relating to analyzing inputs through several different sensing modalities. In particular, one or more available inputs may provide a unique window into a physical environment (e.g., an entity inputting instructions) through several different sensing or input modalities. Because complete details of the phenomena to be observed or analyzed may not be contained within a single sensing/input window, there can be information fragmentation which results from this fission process. These information fragments associated with the various sensing devices may include both independent and dependent components.

The independent components may be used to further fill out (or span) an information space; and the dependent components may be employed in combination to improve quality of common information recognizing that all sensor/input data may be subject to error, and/or noise. In this context, the data fusion/fission techniques employed can include algorithmic processing of sensor/input data to compensate for inherent fragmentation of information because particular phenomena may not be observed directly using a single sensing/input modality. Thus, data fusion/fission provides a suitable framework to facilitate condensing, combining, evaluating, and/or interpreting available sensed or received information in the context of a particular application.

Further, mobile device 202 can also include synthesizing aspects in order to combine, or filter information received from a variety of inputs (e.g., text, speech, gaze, environment, audio, images, gestures, noise, temperature, touch, smell, handwriting, pen strokes, analog signals, digital signals, vibration, motion, altitude, location, GPS, wireless, etc.), in raw or parsed (e.g. processed) form. Such synthesis through combining and filtering can provide a set of information that can be more informative, or accurate (e.g., with respect to an entity's communicative or informational goals) than information from just one or two modalities, for example.

Additionally, mobile device 202 can employ a context component to determine context associated with a particular action or set of input data. As can be appreciated, context can play an important role with respect understanding meaning associated with particular sets of input, or intent of an individual or entity. For example, many words or sets of words can have double meanings (e.g., double entendre), and without proper context of use or intent of the words the corresponding meaning can be unclear thus leading to increased probability of error in connection with interpretation or translation thereof. The context component can provide current or historical data in connection with inputs to increase proper interpretation of inputs. For example, time of day may be helpful to understanding an input—in the morning, the word “drink” would likely have a high a probability of being associated with coffee, tea, or juice as compared to being associated with a soft drink or alcoholic beverage during late hours. Context can also assist in interpreting uttered words that sound the same (e.g., steak and, and stake). Knowledge that it is near dinnertime of the user as compared to the user camping would greatly help in recognizing the following spoken words “I need a steak/stake”. Thus, if the context component had knowledge that the user was not camping, and that it was near dinnertime, the utterance would be interpreted as “steak”. On the other hand, if the context component knew (e.g., via GPS system input) that the user recently arrived at a camping ground within a national park; it might more heavily weight the utterance as “stake”.

Moreover, mobile device 202 can utilize a presentation aspect that can provide various types of user interface to facilitate interaction between a user and any component coupled to mobile device 202. The presentation aspect can provide one or more graphical user interface, command line interface, and the like. For example, a graphical user interface can be rendered that provides the user with a region or means to load, import, read, etc., data, and can include a region to present the results of such. These regions can comprise known text and/or graphic regions comprising dialog boxes, static controls, drop-down menus, list boxes, pop-up menus, edit controls, combo boxes, radio buttons, check boxes, push buttons, and graphic boxes. In addition, utilities to facilitate the presentation such as vertical and/or horizontal scrollbars for navigation and toolbar buttons to determine whether a region will be viewable can be employed.

Users can also interact with regions to select and provide information via various devices such as a mouse, roller ball, keypad, keyboard, and/or voice activation, for example. Typically, mechanisms such as a push button or the enter key on the keyboard can be employed subsequent to entering the information in order to initiate, for example, a query. However, it is to be appreciated that the claimed subject matter is not so limited. For example, merely highlighting a checkbox can initiate information conveyance. In another example, a command line interface can be employed. For example, the command line interface can prompt (e.g., via text message on a display and/or an audio tone) the user for information via a text message. The user can then provide suitable information, such as alphanumeric input corresponding to an option provided in the interface prompt or an answer (e.g., verbal utterance) to a question posed in the prompt. It is to be appreciated that the command line interface can be employed in connection with a graphical user interface and/or application programming interface (API). In addition, the command line interface can be employed in connection with hardware (e.g., video cards) and/or displays (e.g., black-and-white, and EGA) with limited graphic support, and/or low bandwidth communication channels.

Further, mobile device 202 can employ artificial intelligence to facilitate and effectuate its goals and/or aims in accordance with an aspect of the subject matter as claimed. Such an intelligence aspect can employ a probabilistic based or statistical based approach, for example, in connection with making determinations or inferences. Inferences can be based in part upon explicit training of classifiers (not shown) or implicit training based at least in part upon system feedback and/or users previous actions, commands, instructions, and the like during use of the system. The intelligence aspect can employ any suitable scheme (e.g., neural networks, expert systems, Bayesian belief networks, support vector machines (SVMs), Hidden Markov Models (HMMs), fuzzy logic, data fusion, etc.) in accordance with implementing various automated aspects described herein. Moreover, the intelligence aspect can factor historical data, extrinsic data, context, data content, state of the user, and can compute cost of making an incorrect determination or inference versus benefit of making a correct determination or inference. Accordingly, a utility-based analysis can be employed with providing such information to other components or taking automated action. Ranking and confidence measures can also be calculated and employed in connection with such analysis.

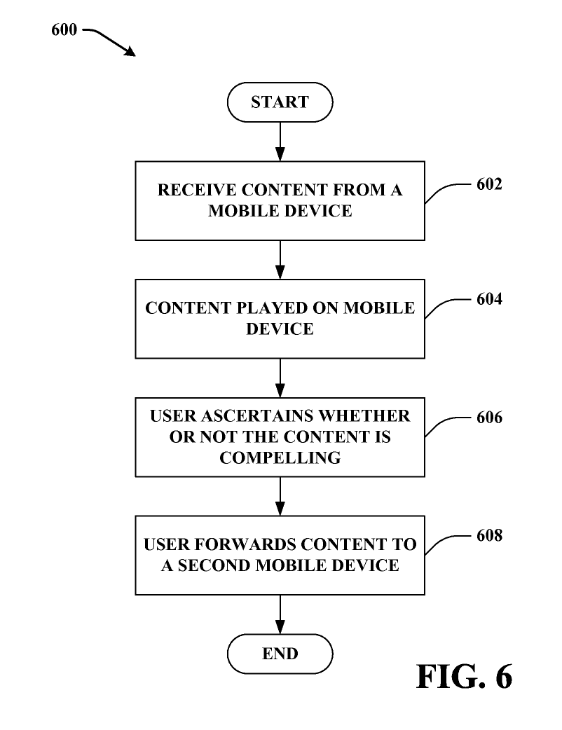

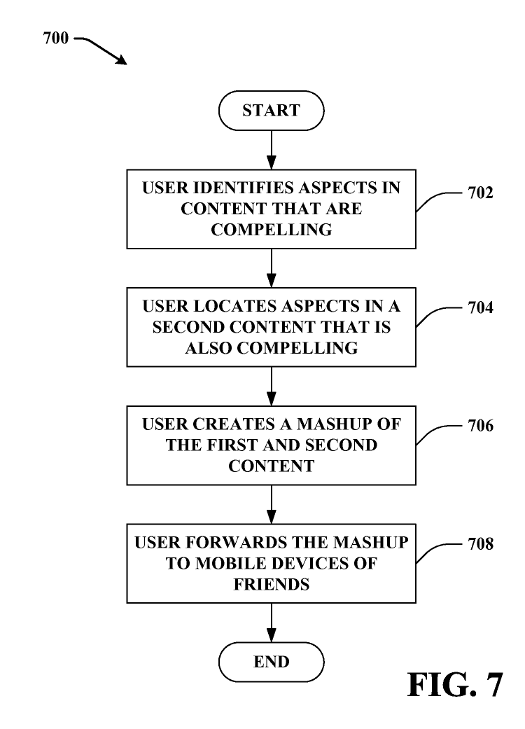

In view of the illustrative systems shown and described supra, methodologies that may be implemented in accordance with the disclosed subject matter will be better appreciated with reference to the flow chart of FIGS. 6-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 6 illustrates a method 600 that effectuates and/or facilitates dispersion of viral advertising content to a disparity of mobile devices in accordance with aspects of the claimed subject matter. Method 600 can commence at 602 where viral advertising content can be received by a mobile device. It is to be appreciated that such viral advertising content can be received directly from another mobile device and that the dissemination of such viral advertising content is typically actuated without the facilities of an intermediary interposed hosting and/or distribution service. At 604 the received advertising content can be played back on an appropriate playback device associated with the mobile device. At 606 the user of the mobile device can ascertain whether or not the received content is interesting, engaging, entertaining, and/or useful. Where the use finds the received material compelling, the user at 608 can forward this information directly to a second mobile device (e.g., a device of one his/her friends) at which point the method can terminate.

FIG. 7 depicts a methodology 700 that effectuates and/or facilitates dissemination of viral advertising content to a plurality of mobile devices in accordance with aspects of the claimed subject matter. Methodology 700 can start at 702 where a user identifies aspects of received viral advertising that he/she finds compelling, engaging, useful, and/or entertaining. At 704 the user can locate (e.g., from a repository of other received viral advertising content or content of the user's making) aspects in a second received viral advertisement content that he/she finds equally compelling. At 706 the user can splice the first and second aspects to create a mashup or hybridization of the viral advertising content which he/she can forward directly to the mobile devices of his/her friends at 708.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

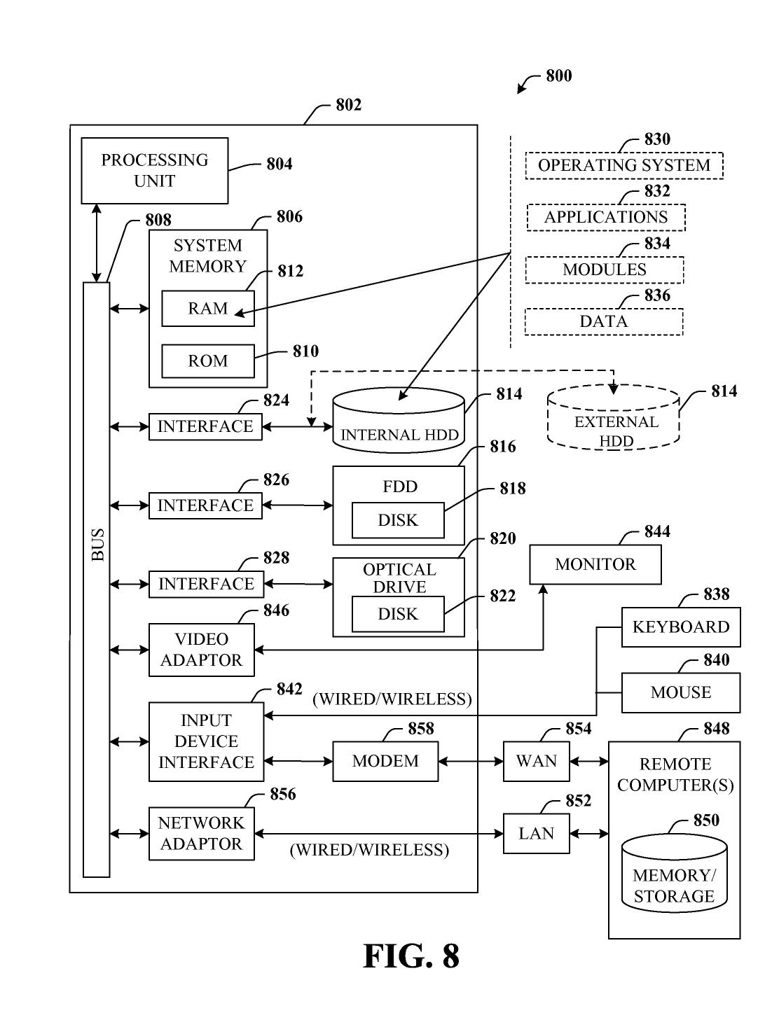

Referring now to FIG. 8, there is illustrated a block diagram of a computer operable to execute the disclosed system. In order to provide additional context for various aspects thereof, FIG. 8 and the following discussion are intended to provide a brief, general description of a suitable computing environment 800 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 8, the illustrative environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 812, including an operating system 830, one or more application programs 832, other program modules 834 and program data 836. All or portions of the operating system, applications, modules, and/or data can also be cached in the RAM 812. It is to be appreciated that the claimed subject matter can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1094 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are illustrative and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10 BaseT wired Ethernet networks used in many offices.

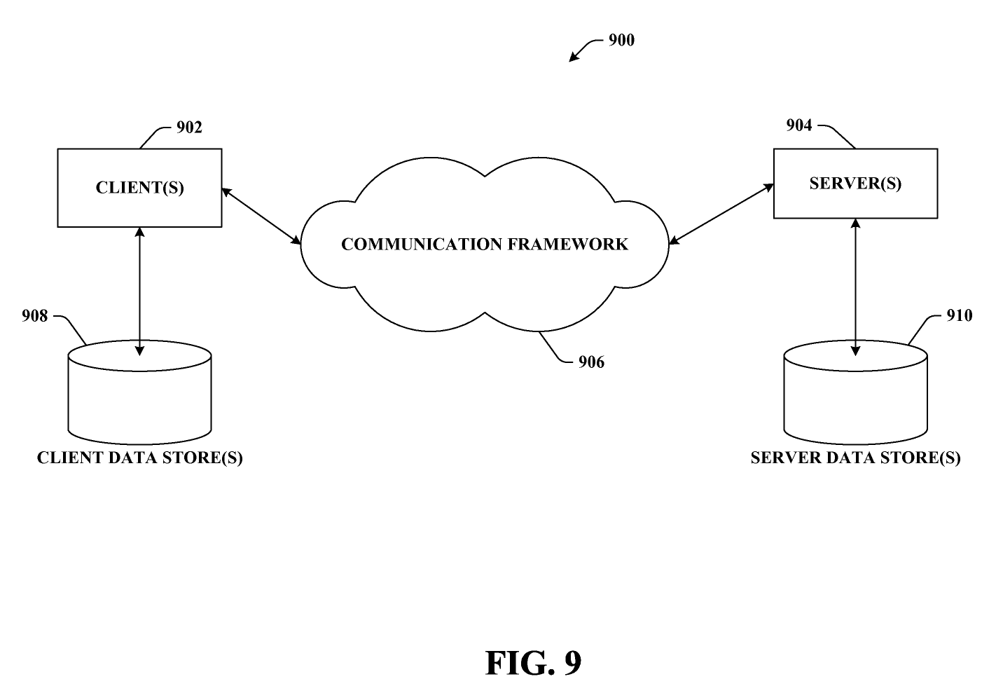

Referring now to FIG. 9, there is illustrated a schematic block diagram of an illustrative computing environment 900 for processing the disclosed architecture in accordance with another aspect. The system 900 includes one or more client(s) 902. The client(s) 902 can be hardware and/or software (e.g., threads, processes, computing devices). The client(s) 902 can house cookie(s) and/or associated contextual information by employing the claimed subject matter, for example.

The system 900 also includes one or more server(s) 904. The server(s) 904 can also be hardware and/or software (e.g., threads, processes, computing devices). The servers 904 can house threads to perform transformations by employing the claimed subject matter, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that effectuates or facilitates dispersion of viral advertising content, comprising:
a memory that retains instructions for receiving the viral advertising content, modifying the viral advertising content with further viral advertising content previously received from a disparate mobile device, determining a set of recipients to whom the modified viral advertising content is appealing, and forwarding the modified viral advertising content to the set of recipients; and
a processor, coupled to the memory, that executes the instructions retained in the memory.

2. The system of claim 1, the viral advertising content received directly from a mobile device.

3. The system of claim 1, the modified viral advertising content forwarded directly to one or more mobile devices associated with a subset of individuals included in the set of recipients.

4. The system of claim 1, the memory further retains instructions for ensuring that the viral advertising content is selectively non-associable with the further viral advertising content, where the viral advertising content is attributable to an advertiser or the further viral advertising content is attributable to a competitor of the advertiser.

5. The system of claim 1, the memory further retains instructions for monitoring whether the received viral advertising content is displayed on a mobile device.

6. The system of claim 5, based at least in part on the monitoring, assigning a tariff to segments of the received viral advertising content, the tariff assigned to the segments of the received viral advertising content based on a popularity rating associated with the segments of the received viral advertising content.

7. The system of claim 1, the memory further retains instructions for ensuring that a digital rights management (DRM) attribution is persisted with the viral advertising content forwarded to the at least one of the set of recipients or a subset of individuals included in the set of recipients.

8. A machine implemented method for effectuating dissemination of viral advertising content, comprising:
receiving the viral advertising content on a mobile device;
modifying the viral advertising content with further viral advertising content previously persisted on the mobile device;
determining a set of recipients to whom modified viral advertising content is useful; and
forwarding the modified viral advertising content to the set of recipients each associated with a disparate mobile device.

9. The method of claim 8, the viral advertising content received directly from an initial mobile device associated with a user excluded from the set of recipients.

10. The method of claim 8, the modified viral advertising content forwarded directly to the disparate mobile device associated with each individual included in the set of recipients.

11. The method of claim 8, further comprising splicing the viral advertising content directly received by the mobile device with content created locally on the mobile device, the spliced viral advertising content forwarded to at least one of the set of recipients or a subset of individuals included in the set of recipients.

12. The method of claim 8, further comprising monitoring whether the received viral advertising content is displayed on the mobile device.

13. The method of claim 12, based at least in part on the monitoring, assigning a tariff to segments of the received viral advertising content, the tariff assigned to the segments of the received viral advertising content based on a popularity rating associated with the segments of the received viral advertising content, the tariff employed by an advertiser to compensate a user that forwards the modified viral advertising content to the set of recipients, wherein at least one of the set of recipients views the modified viral advertising content.

14. The method of claim 8, further comprising ensuring that a digital rights management (DRM) attribution is persisted with the viral advertising content forwarded to at least one of the set of recipients or the subset of individuals included in a set of recipients.

15. A system that disseminates of viral advertising content, comprising:
means for receiving the viral advertising content;
means for modifying the viral advertising content with content previously received or persisted with the means for receiving;
means for determining a set of recipients to whom the modified viral advertising content is useful; and
means for forwarding the modified viral advertising content to the set of recipients each associated with a means for receiving.

16. The system of claim 15, the viral advertising content received directly from means for propagating associated with a user excluded from the set of recipients.

17. The system of claim 15, the modified viral advertising content forwarded directly to the means for receiving associated with each individual included in the set of recipients.

18. The system of claim 15, further comprising means for joining the viral advertising content directly received from a means for propagating with content created locally on the means for receiving, the joined viral advertising content forwarded to at least one of the set of recipients or a subset of individuals included in the set of recipients.

19. The system of claim 18, the means for joining one of maintains a digital rights attribution with the viral advertising content or maintains the digital rights attribution with the content created locally.

20. The system of claim 15, further comprising means for monitoring whether the received viral advertising content is displayed on the means for receiving.
